(19) United States
(12) Patent Application Publication
(10) Pub. No.: US 2003/0033724 A1
(43) Pub. Date: Feb. 20, 2003

(54) Tile placement measurement tool with adjustable reference edges

(76) Inventor: William Barbosa, Pompano Beach, FL (US)

Correspondence Address: ZITO tlp, Suite 203, 26005 Ridge Road, Damascus, MD, 20872, US

(21) Appl. No.: 10/144,434

(22) Filed: May 10, 2002

Related U.S. Application Data
(60) Provisional application No. 60/290,325, filed on May 11, 2001.

(51) Int. Cl. G01D 21/00

(52) U.S. Cl. 33/526

(57) ABSTRACT

A tool for measuring the opening for a floor tile and for transferring that measurement to the a floor tile so that a floor tile may be cut to fit the opening.

### BACKGROUND

The present relates to the measuring and cutting of tiles for installation. More specifically, the present invention relates to a tool for measuring the installation location for a tile which must be cut to fit into the installation location. When tiles are installed on a wall, floor or other surface, the tiles in the center of the surface can be installed as whole tiles, the tiles around the edges and/or around other objects on the surface may have to be cut prior to installation to fit the surface being tiled.

Prior art tools for measuring tile have included specially designed rulers such as taught in U.S. Pat. No. 5,870,831 and embodied in the Eberline tile measuring tool, and paper templates such as taught in U.S. Pat. No. 5,922,157.

### SUMMARY OF THE INVENTION

The present invention is a hand-held tool which has a pair of reference elements which can be slid along guide rods to position the reference elements at selected reference points in the open location for a tile. By positioning the reference elements in the location for the tile, and locking the reference elements on the guide rods, the dimensions and configuration of the opening are accurately recorded for reference when marking the tile to be cut. The configuration of the reference elements is then transferred to the tile to be cut to fit the opening.

A first one of the reference elements, shaped the same as one edge of a tile, for example, either a straight edge reference bar or a corner edge reference triangle, is placed against one edge of the open space. A second reference element is moved into position to contact another edge of the opening. The reference elements are clamped in place, retaining the orientation and distance between the measured edges of the opening. The tool is then placed on the tile to be cut, aligning the first reference element with one edge of the tile and then the orientation of the second reference element is marked on the tile and the tile is cut to fit the opening. In some openings, fitting of the tile will only require a single measurement and cut. In other openings, in may be necessary to make several measurements and several cuts to different edges of the tile to shape the tile to fit the opening.

A number of differently shaped reference elements can be attached to the guide rails to accommodate a variety of tile locations. The present invention teaches the use of a triangular shaped reference element to fit the apex of a tile corner location. Straight reference elements are also taught for referencing the location of a flat surface such as a wall or the flat side of a tile. Various other reference elements members, such as a circular elements which fit the dimensions of a plumbing fixture or hole such as a sink, toilet or drain can also be used to gauge the distance and location to such plumbing fixture.

One of the reference elements is placed against one side of the opening where a tile is needed and the other reference element is adjusted along the guide rods until the second reference element is in position to define the dimensions of the opening requiring a cut tile. The reference element is then locked in place through the use of clamps securing the reference element to the guide rods. Once clamped in place, the tool can be moved while maintaining the configuration of the opening. This configuration is then accurately transferred to the tile to be cut.

By providing a tool which can be locked into an appropriate configuration, the need to transport a tile back and forth between the installation location and the tile cutting location is eliminated. The tile can be left at the cutting location while the tool is brought to the installation location and a measurement is taken and locked in place. The tool is then returned to the tile supply/cutting location for transfer of the correct tile configuration and cutting.

The connection between the reference elements and the guide rods can allow for rotation of the orientation between the two parts of the tool. The reference elements can then be oriented in any manner such as parallel or at acute or obtuse angles relative to each other. The ability to orient and lock the reference element tools allows for the accurate configuration measurement of a wide variety of tile placement opening configurations.

The floor tile installation tool measures the space where tile is missing and keeps an accurate measurement without having to place a tile on top of another tile. In the preferred embodiment, measurement is locked and the tool can be carried if needed.

Moving heavy materials back and forth between the cutting device and the tile installation location adds risk of damage to the tile and requires added effort to each cut that has to be performed. Placing one tile adjacent to or on top of another tile for measuring risks damage to the tiles and creates inaccuracies in measurement. The tool of the preferred embodiment, increases accuracy and simplicity over the prior art. Waste due to bad measuring is significantly reduced and time spent marking and cutting tiles is significantly reduced.

One embodiment includes a grout spacer to accommodate the grout used between tiles. An alternative embodiment does not contain a grout spacer. Some tiles are placed edge to edge and do not contain grout and no space is required.

A number of different accessories can be attached to the adjustable guide rod brackets. The preferred and alternative embodiments can be constructed of different materials to suit different consumer needs, such as plastic, aluminum, steel, and alloys. The tool of the preferred embodiment is constructed in various sizes to perform measurements for all sizes of tile. The tool is also applicable for use in measuring and cutting drywall and similar construction and installation needs.

### BRIEF DESCRIPTION OF THE DRAWINGS

FIG. 1 illustrates a first embodiment of the present invention having a single slide bar.

FIG. 2 illustrates the disassembled components of tool of the embodiment of FIG. 1.

FIG. 3 illustrates an alternative embodiment of the tile marker tool of the present invention having dual slide bars.

FIG. 4 illustrates an alternative construction for the embodiment of the tool of FIG. 3.

Figures of 5A and 5B illustrate use of the tile marker tool of FIG. 4 to measure a rectangular tile opening and to transfer the measurement to a tile to be cut.

FIG. 6 illustrates a the use of a reference bar without a grout spacer to measure an opening and mark a tile.

FIG. 7 illustrates the use of a reference bar with a grout spacer to measure an opening and mark a tile.

FIGS. 8A, 8B and 8C illustrate the use of the tile marker tool of FIG. 4 using a reference triangle to measure an opening and to transfer the measurement to a tile to be cut to fit the opening.

FIG. 9 illustrates the tool embodiment of FIG. 3 with an adjustable triangular reference element.

FIG. 10 illustrates the use of the tile measuring device of FIG. 4 to measure an irregular shaped opening and to transfer the measurement to a tile to be cut to fit the irregular shaped opening.

FIG. 11 illustrates the tool of FIG. 4 with the addition of a corner guide for L shaped cuts.

FIG. 12 illustrates the use of the tile measuring device of FIG. 1 to measure a number of different shaped openings.

FIG. 13 illustrates the use of the circular reference element of FIG. 12 on the tool of FIG. 1.

FIG. 14 illustrates the tool for measuring and marking the location of a hole to be cut in a tile.

FIGS. 15A and 15B illustrate an additional alternative embodiment of the present invention used to take single point measurement of the distance from a tile edge to an obstacle.

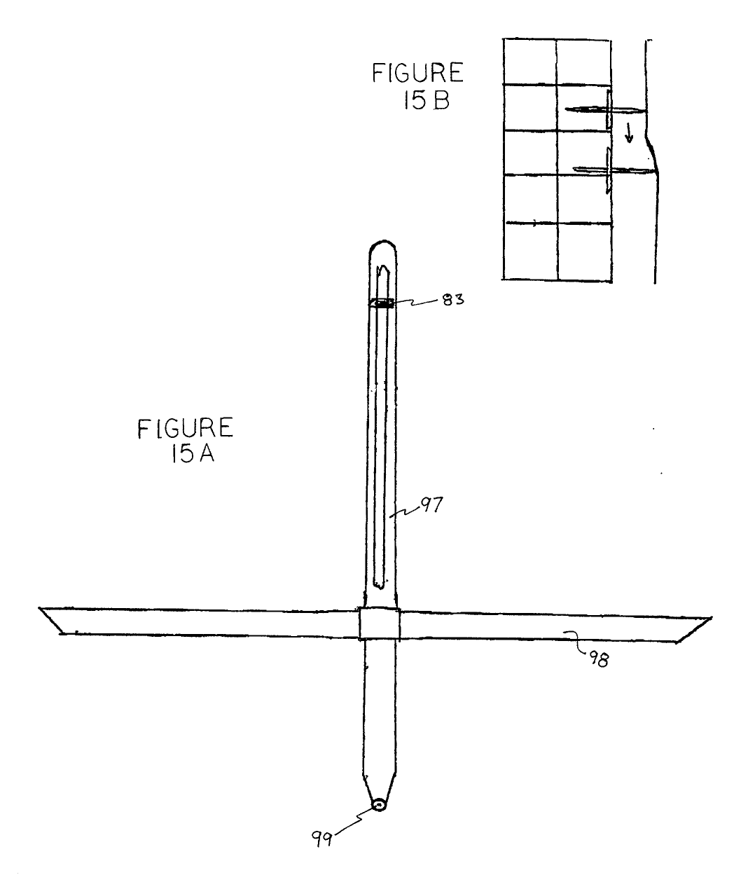

### DETAILED DESCRIPTION OF PREFERRED EMBODIMENTS

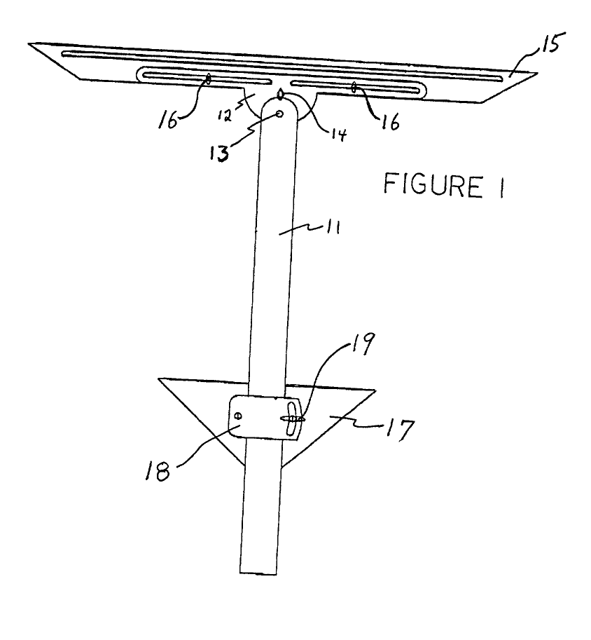

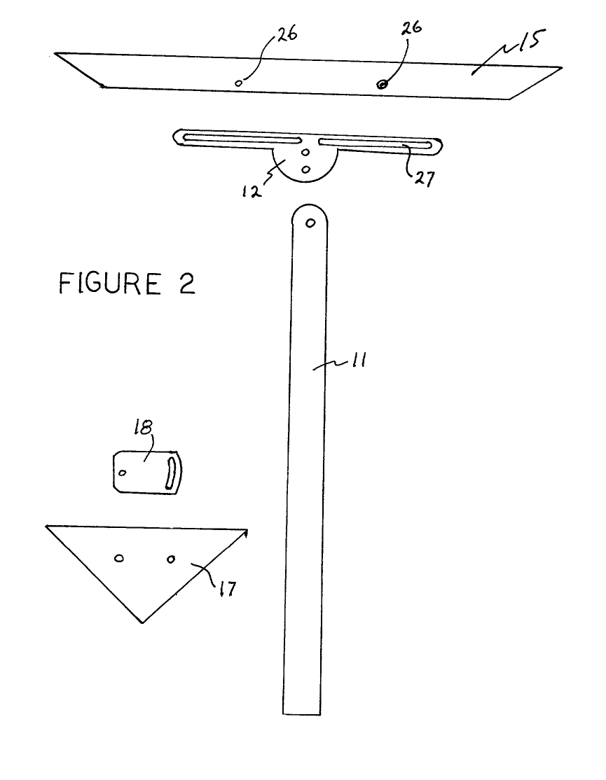

As illustrated in FIG. 1, in a first embodiment of the present invention, the tool has a guide bar 11 with a reference element holder 12 pivotally attached to the guide bar 11 at the point 13 at one end of the guide bar. A clamping element 14 is used to secure the holder 12 to the guide bar to prevent pivoting about point 13. The reference element bar 15 is attached to holder 12 by attachment bolts 16 which extended through holes 26 illustrated in FIG. 2 into slots 27. The use of attachment bolts 16 and slots 27 allows for the reference element bar 15 to be moved transverse to the long axis of the guide bar 11. The guide bar 11 can be a flat guide bar as illustrated in the exemplary embodiment of FIG. 1 or can be alternatively a round guide bar or may at any desired cross-section such as square or hexagonal.

Near the other end of the guide bar 11, a second reference element illustrated in this embodiment has reference triangle 17 is held in position by clamp 18. Reference triangle 17 can slide up and down the long axis of the guide bar 11. Reference triangle 17 is held in position on guide bar 11 by tightening of bolt 19 of clamp 18.

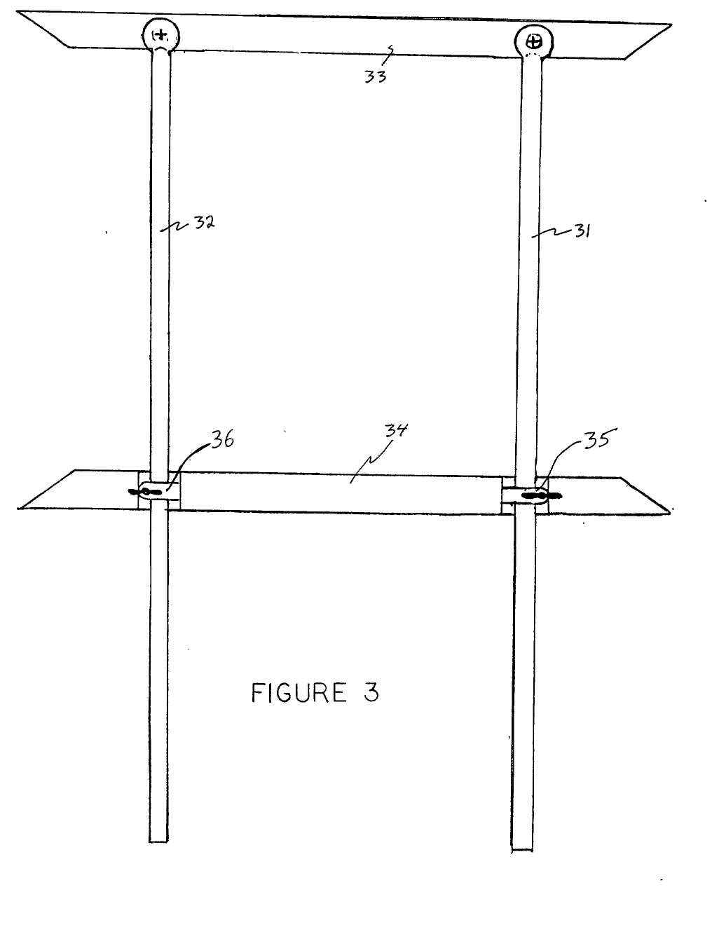

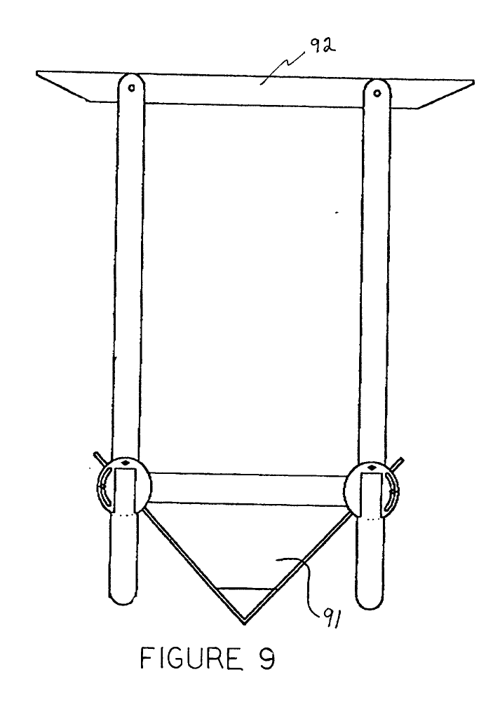

FIG. 3 illustrates an alternative embodiment of the tool of the present invention which utilizes to round guide bars 31 and 32. The tool of FIG. 3 also utilizes a reference bar moment 33 pivotally attached to each of the guide bars 31 and 32. The tool of FIG. 3 is currently configured to measure flat surfaces at each and has shown by the second reference bar 34. The second reference bar 34 is able to slide on the guide bars 31 and 32 and is secured in position by use of clamps 35 and 36. The tool of the embodiment of FIG. 3 can also be configured to measure corner surfaces in the configuration as illustrated in FIG. 9.

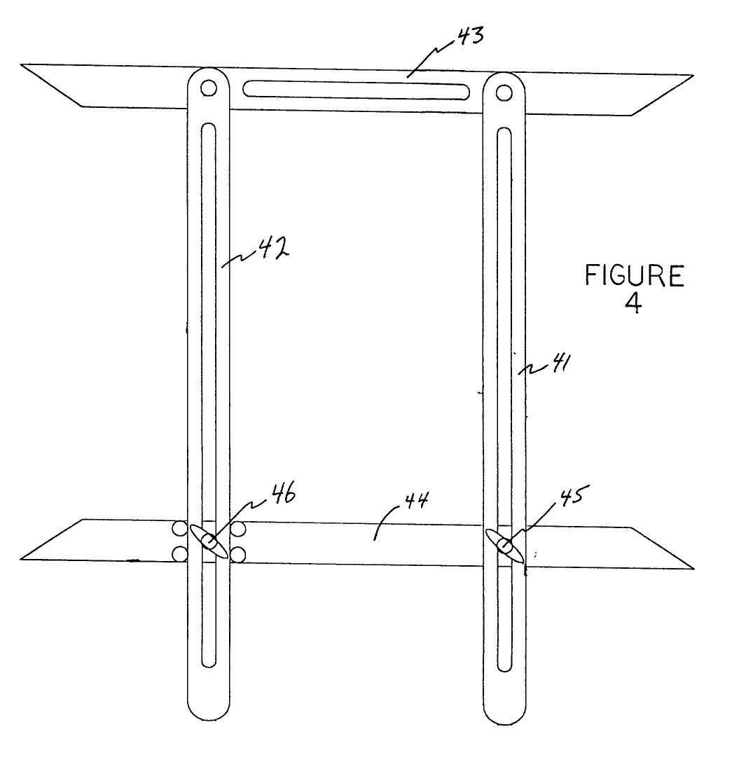

FIG. 4 illustrates yet another alternative embodiment which, like the embodiment of FIG. 3, includes two guide bars 41 and 42. The reference bar element 43 of the embodiment of FIG. 4 is also pivotally attached to each of the guide bars. The embodiment of FIG. 4 illustrates a different clamping mechanism for securing the second reference bar 44 to the guide bars 41 and 42. The clamping mechanism 45 and 46 includes a bolt and wing nut which can be tightened or loosened to secure second reference bar 44 onto guide bars 41 and 42.

FIG. 5A illustrates the use of the tool 51 of the present invention for measuring the size of an opening a partially tiled floor. As illustrated, a number of tiles 52 have already been delayed and secured in position on the floor 53. The gap remaining between the installed tiles 52 and the walls 54 of the room is insufficient to fit whole tiles. Therefore, tiles must be cut in order to fit tiles into the space remaining to be filled. Each opening which requires a tile must be individually measure in order to determine the appropriate size to cut a tile fit the opening. First, either the first reference bar 43 is placed against the wall 54 for the second reference bar 44 is placed against the edge of tile 52. Once either of these two reference bars in place, the second reference bar 44 is slid relative to the guide bars 41 and 42 until the other reference bar is against the other reference surface. The two reference bars can be adjusted because of the pivotal attachment to the guide bars, so that both reference bars fit in good online with the respective reference surfaces. Once both reference bars 43 and 44 rest securely against their respective reference edges, clamps 45 and 46 are tightened in order to retain the size measurement that the tool now represents.

FIG. 5 illustrates the transferring of the size measurement to the tile 55 which is to be tile to fit into the opening. The edge of second reference bar 44 is aligned with the edge of tile 55. A mark is made on tile 55 in alignment with the edge of first reference bar 43. The tool can then be removed and the tile can be cut along the mark and the tile will fit accurately into the opening measured by the tool of the present invention.

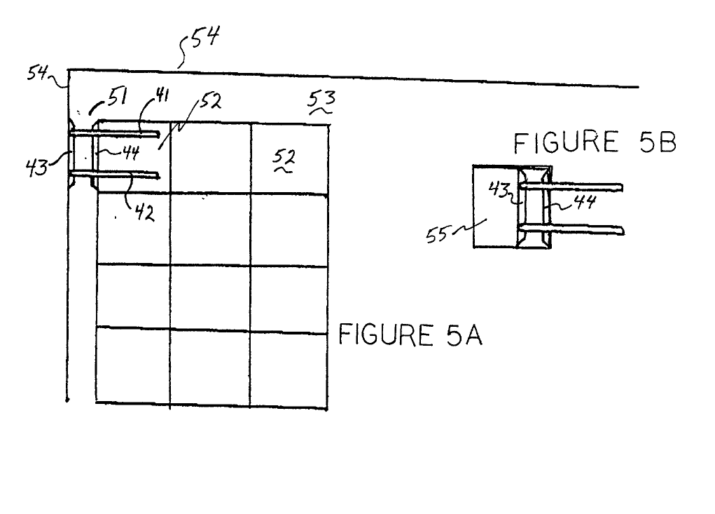

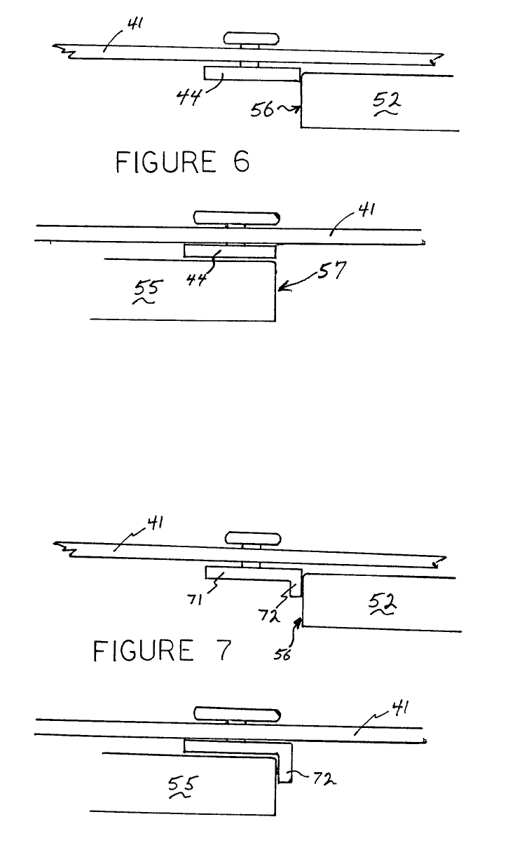

FIG. 6 illustrates how the alignment bar 44 is first positioned against the edge 56 from the of the previously installed in place tile 52 and then how the same alignment bar 44 is aligned with the edge 57 of the tile to 55 which is to be cut to fit into the measured opening. FIG. 7 illustrates an alignment bar 71 which includes a grout spacer element which consists of a flange 72 on one side of the alignment bar 71. As illustrated in FIG. 7 when measuring the size of the opening, the flange 72 is positioned against the edge 56 of installed tile 52. When transferring the size measurement to the tile to be cut 55, the flange 72 hangs over the edge the 57 of tile 55. The measurement mark the made on the tile by the first alignment bar 43 will therefore be offset by an amount equal to the thickness of the grout gap flange 72. This grout gap allows for the tile to be cut with a sufficient space to allow grout to the placed properly around the tile if such is desired. Any of the reference elements taught by the present invention, including the reference bars and reference triangles can be provided with a grout gap flange to allow for clearance for grouting around the tiles.

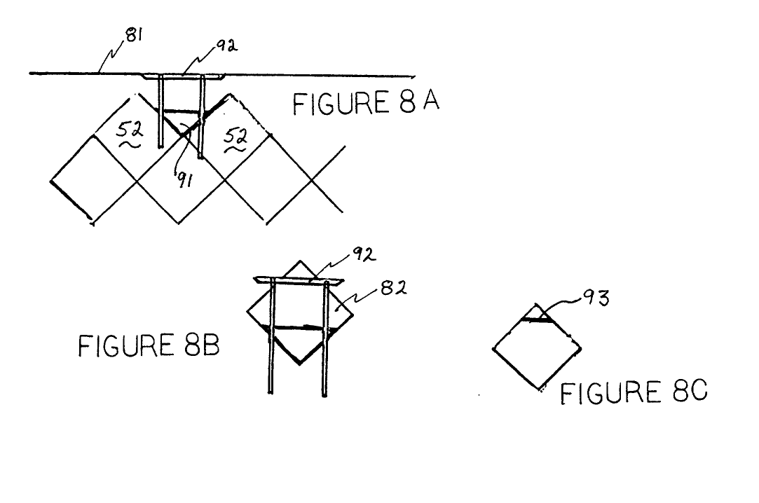

FIG. 8A illustrates the same process when measuring and opening which includes a comer. The embodiment of the present invention as illustrated in FIG. 9 with a triangular reference element 91 can be used to measure the opening illustrated in FIG. 8A. The triangular reference element 91 is placed in the comer formed by the tiles 52 which all already installed in place. The guide bars are than adjusted in their clamps until the opposite reference bar 92 rests against the surface 81. Once in place, the clamps are tightened and the size of opening is retained. The tool is then move to an placed on the tile to be cut 82 as illustrated in FIG. 8B. A mark 93 in alignment with the opposite reference guide bar 92 is made on tile 82. Tile 82 can then be cut along mark 83 as illustrated in FIG. 8C.

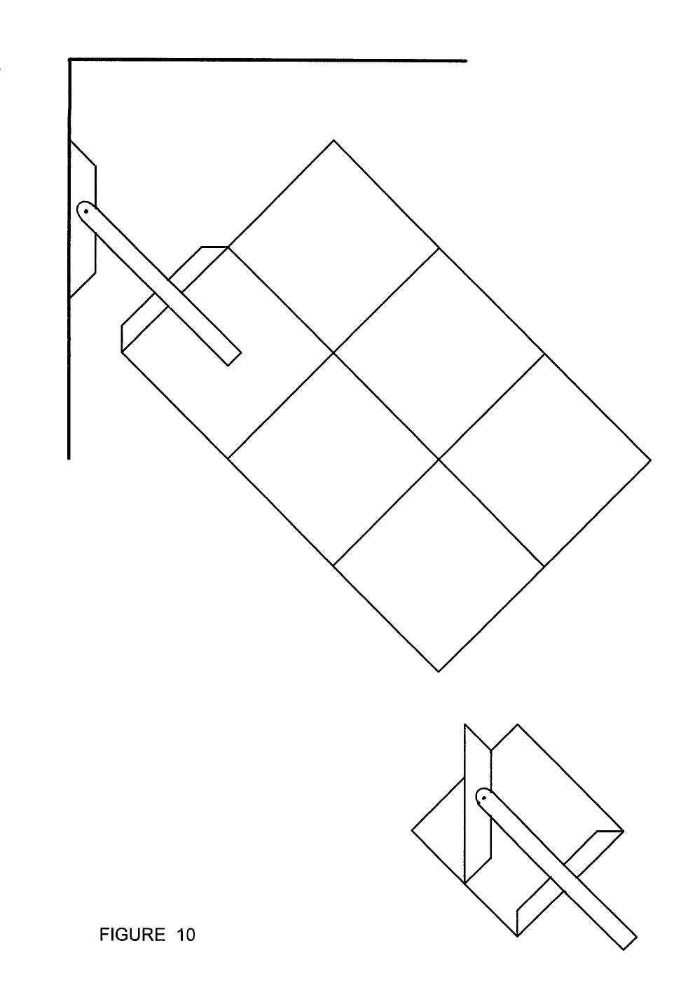

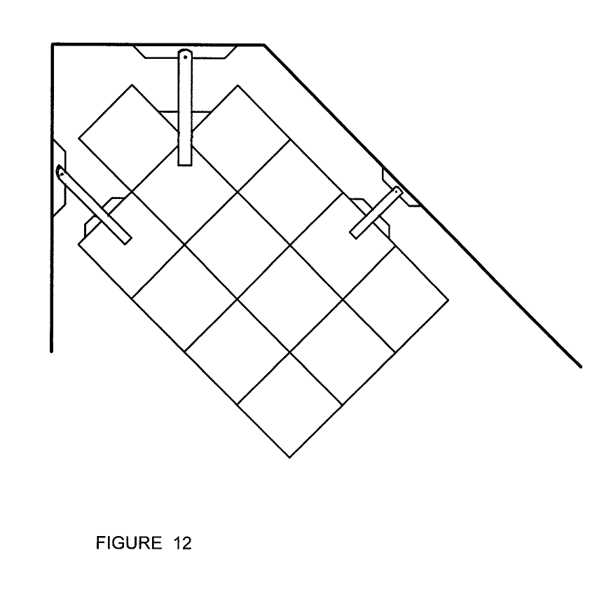

FIG. 12 illustrates how the same types of measurements of opening can be made utilizing the single guide bar embodiment of the tool of the present invention as illustrated in FIG. 1. One of the reference elements is placed against one edge of the opening, the guide bar and remaining reference element is adjusted until the edges of the opening have been measured. The reference element and guide bar are secured and the tool is moved into position for marking a tile to be cut to the size of the opening measured. FIG. 10 illustrates the application of the embodiment of the tool of the present invention as illustrated in FIG. 1 when cutting an irregular shape for a tile to fit into an opening.

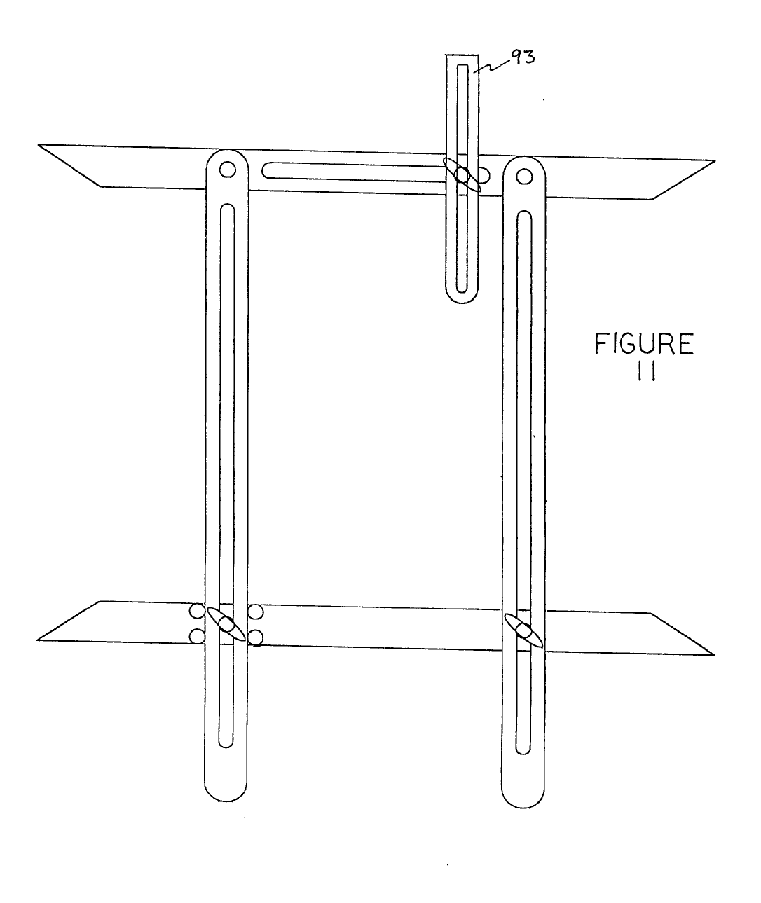

FIG. 11 illustrates a corner guide adaptor 93 which can be used with any of the embodiments of the tool of the present invention. The corner guide adaptor is illustrated the use with the embodiment of FIG. 4. The adaptor is use when a L shaped cut is to be made in a tile such as might occur when cutting around a door frame, a corner of a wall or protrusion into a floor.

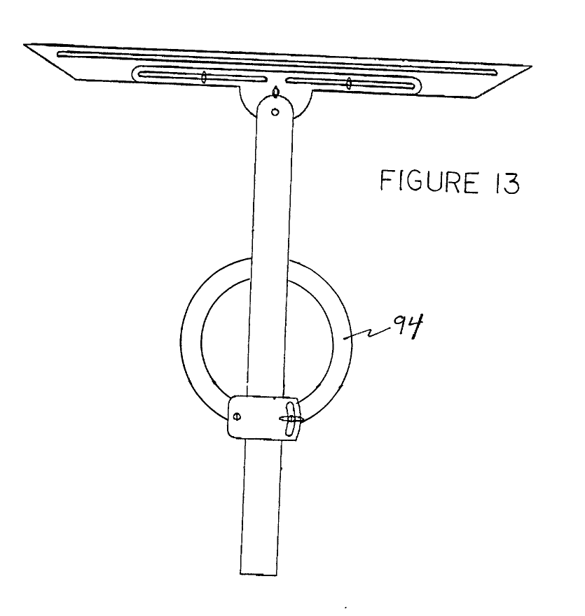

FIG. 13 illustrates a circular adaptor 94 which is used to measure tile position in reference to the circular object such as a toilet drained opening or other plumbing fixtures. The embodiment of the tool of present invention illustrated in FIG. 13 is used in the same manner as explained above to measure an opening to cut the tile.

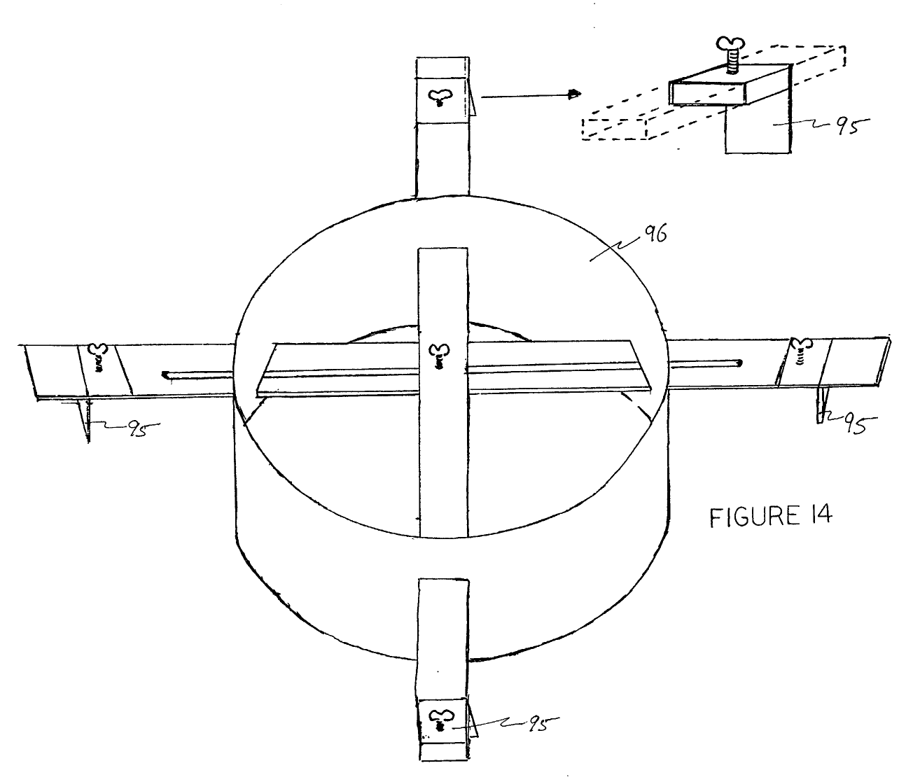

FIG. 14 illustrates yet another embodiment of a tool utilizing some all the principles taught by the present invention. The flange is 95 are used as reference elements to position a circular marker 95 to mark the position for cutting a circular a tile.

Figure is 15A and 15B illustrates the use of a reference bar to mark the profile of an irregular obstacle which needs to have tiles cut to fit the irregularity of the obstacle. A single guide bar 97 is provided with a single reference element 98. One end of the guide bar provided with a wheel 99. The opposite end has a slidable guide 83 for holding a marking device such as a pencil. As the tool is moved along, the irregularity of the obstacle can be recorded by the marking device.

The guide bar is provided in various lengths to accommodate various size tiles. The reference bars also are provided in a variety of lengths to accommodate different size tiles.

Because many varying and different embodiments may be made within the scope of the inventive concept herein taught, and because many modifications may be made in the embodiments herein detailed in accordance with the descriptive requirements of the law, it is to be understood that the details herein are to be interpreted as illustrative and not in a limiting sense.

What is claimed:

1. A tool for measuring the opening for a floor tile to be added to in place floor tiles to continue tiling an area to be tiled, comprising:
a guide bar;
a first reference element slidably mounted to said guide bar, for positioning against an edge surface of an in place tile;
a second reference element pivotally mounted to said guide bar, for positioning against an edge of the area to be tiled; and
clamps for securing each of said reference elements in position on said guide bar.
